(19) United States
(12) Patent Application Publication
(10) Pub. No.: US 2012/0126513 A1
(43) Pub. Date: May 24, 2012

(54) Adjustable Wheelchair

(76) Inventors: Richard Vincent Kent, Portland, OR (US); Wayne Summers, Seattle, WA (US)

(21) Appl. No.: 13/300,465

(22) Filed: Nov. 18, 2011

Related U.S. Application Data
(60) Provisional application No. 61/415,326, filed on Nov. 18, 2010.

(51) Int. Cl. A61G 5/08

(52) U.S. Cl. 280/650

(57) ABSTRACT

An adjustable wheelchair to facilitate width adjustment to accommodate varying wheelchair size needs where the wheelchair includes a pair of spaced side assemblies that support a pair of wheels, a seat and a backrest; at least a pair of T-members that are rotatably connected to the side assemblies; at least a pair of legs that are securely fastened to the side assemblies; an X-member formed by at least two hollow tubes that are pivotally connected where the X-member is placed between the side assemblies and where the T-members and the legs are adjustably lockable to the X-member in order to easily size the wheelchair.

### FIELD OF THE INVENTION

The present invention claims priority to U.S. Provisional Patent Application No. 61/415,326, filed on 2010 Nov. 18 and the disclosure of that application is incorporated herein by the reference. The present invention is in the art of a wheelchair construction having a frame, a seat, a back rest, wheels, arm rests and foot rests assemblies adjustably connected together. Main rear wheels (with or without quick release) and front caster wheels connected to the frame to support the wheelchair on a floor or similar surface.

### BACKGROUND OF THE INVENTION

There are many types of wheelchairs and they have long been developed so as to be increasingly usable and readily operable for the user sitting in the wheelchair. In general, wheelchairs have most or all of the following components: a seat on which the user sits, a back rest in connection with the seat, handles in connection with the back rest for use by others to assist the user to move the wheelchair, foot rests if needed, wheels and a chassis or a frame which supports the previously mentioned components.

There have been many variations to the standard wheelchair including many mechanical and electronic varieties. However, the basic design has remained relatively unchanged. Conventional wheelchairs have metal frames of tubular members secured together with welds to specific sizes. The parts of these welded chairs are not adjustable to allow for different wheelchair sizes and dimensions. Separate frames must be constructed for different wheelchair sizes and shapes. Therefore, companies that sell wheelchairs must keep a constant stock of different sized wheelchairs. This is inefficient, takes up storage space and is expensive for the manufacturer, the seller and for the end user.

### SUMMARY OF THE INVENTION

The object of the present invention is hence to realize a simplified adjustable wheelchair with a frame width that is separately adjustable without additional alteration of other parts. The wheelchair of the present invention has lockably and releasably connecting parts that allow for easy wheelchair frame width adjustment and part replacement.

The object forming the basis of the present invention will be attained if the wheelchair intimated by way of introduction is characterized in that the frame is easily horizontally width adjustable by using slideably, connectable tubing, or arms configured in a scissors design. This scissors, or X design, features an X shaped center piece that is pivotally connected in the center and is adjustably connected to a pair of side frame assemblies disposed in a spaced apart side by side relationship with each of the side frame assemblies having upper and lower frame members rigidly interconnected to front and rear frame members. The seating is connected to each of the side frame assemblies and is easily adjustable using Velcro™ or some other similarly adjustable material. Large rear wheels with or without quick release mechanisms are removably connected to the rear of the tubular frame. Smaller front caster wheels are removably attached to the front support to allow the chair to easily turn. Removable foot rest assemblies are also easily attachable to the front portion to accommodate the legs and feet of the person seated on the wheelchair. Velcro™ or some other similarly adjustable material is used for the seat backing. Finally, the handles can be fixed or adjustable to a specified length.

### BRIEF DESCRIPTION OF THE DRAWINGS

The present invention will now be described in greater detail hereinbelow with reference to the accompanying Drawings.

FIG. 1 is a perspective view of a wheelchair of the present invention;

FIG. 2 is a perspective view of a wheelchair of the present invention with seat and back straps open;

FIG. 3 is a close up view of the seat and back of the present invention;

FIG. 4 is a close up view of the seat and back of the present invention;

FIG. 5 is a view of the present invention showing the seating material as placed on the seat;

FIG. 6 is a perspective view of the wheelchair of the present invention with the seat padding and back padding in place;

FIG. 7 is a side view of a wheelchair of the present invention;

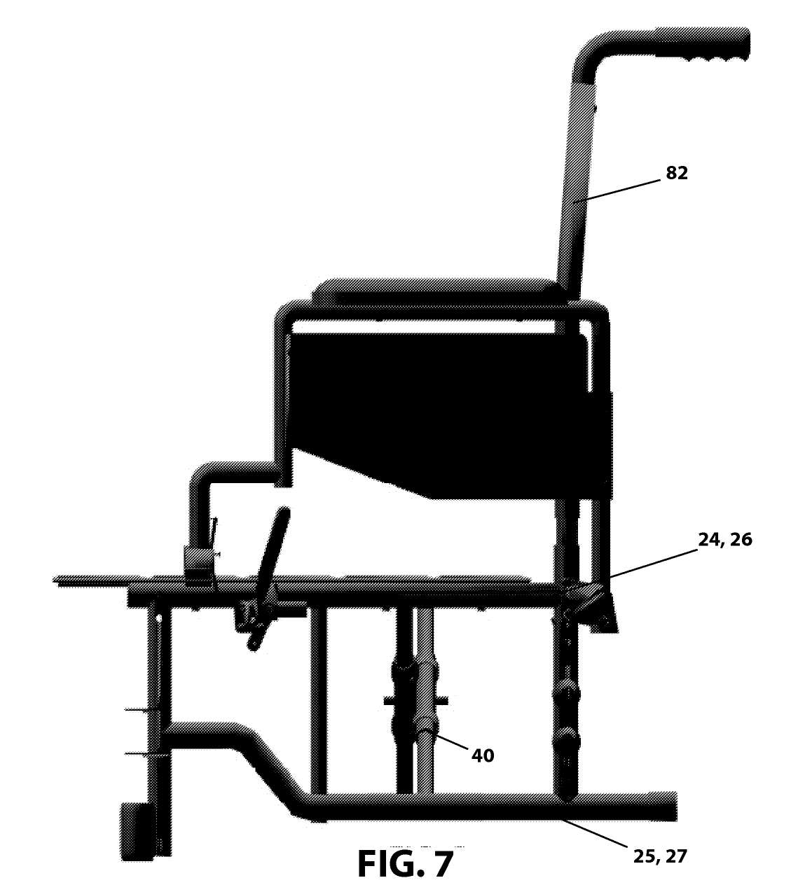

FIG. 8 is an elevational view of a chair of the present invention;

FIG. 9 is an exploded elevational view of a chair of the present invention.

FIG. 10 is an exploded elevational view of a chair of the present invention showing the lock rings.

FIG. 11 is an elevational view of a chair of the present invention.

FIG. 12 is a close up view of the lock ring used in a chair of the present invention.

FIG. 13 is a top view of a chair of the present invention when open.

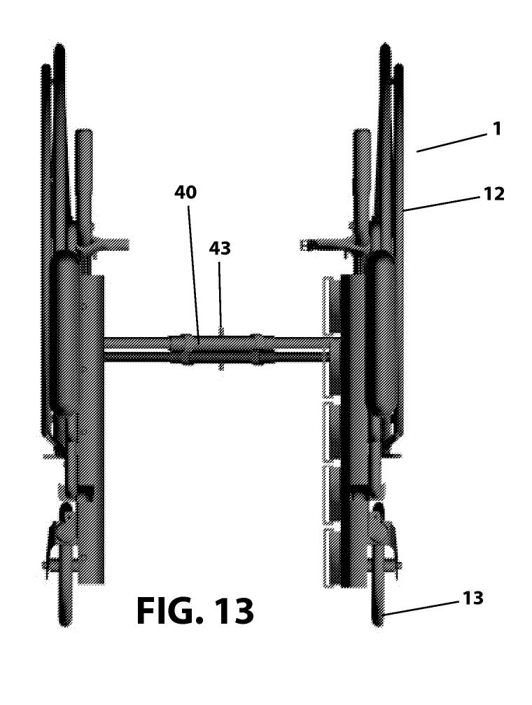

FIG. 14 is an exploded, elevational frontal view of a chair of the present invention.

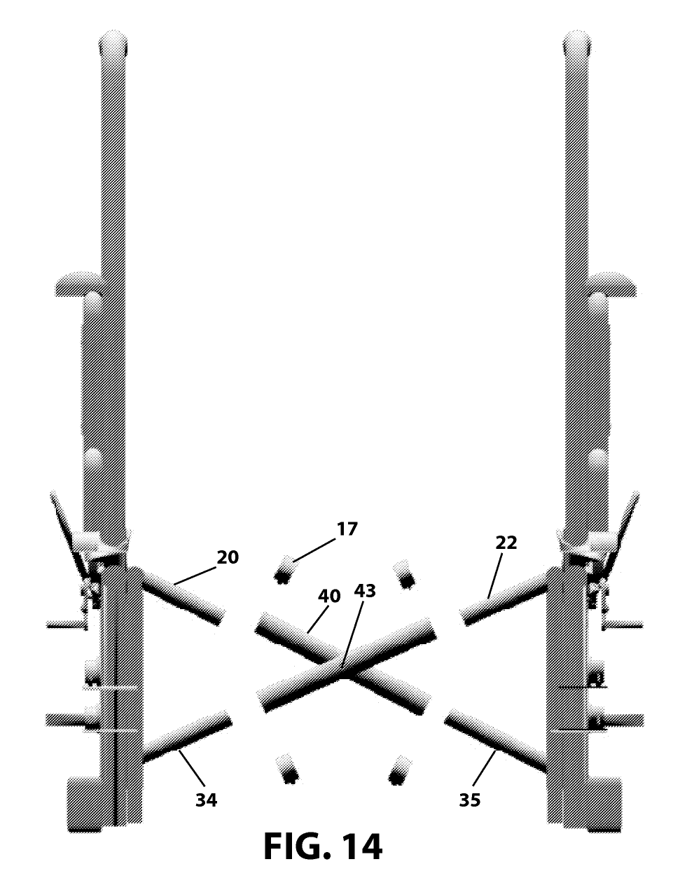

FIG. 15 is a close up view of the X-member as used in a chair of the present invention.

FIG. 16 is an exploded elevational top view of a chair of the present invention.

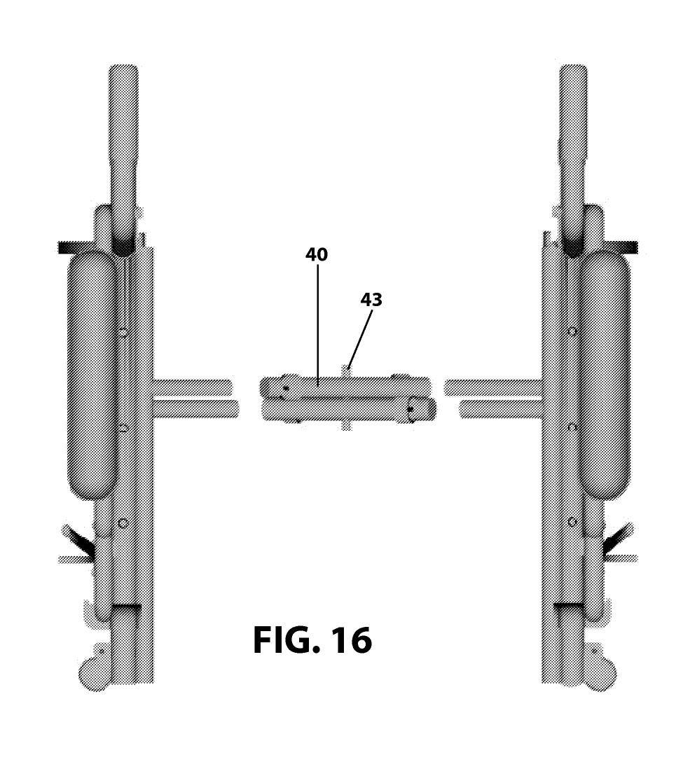

FIG. 17 is a close up view of the X-member as used in a chair of the present invention.

FIG. 18 is a frontal view of a chair of the present invention.

FIG. 19 is an elevated top view of a chair of the present invention when closed.

### DETAILED DESCRIPTION OF THE INVENTION

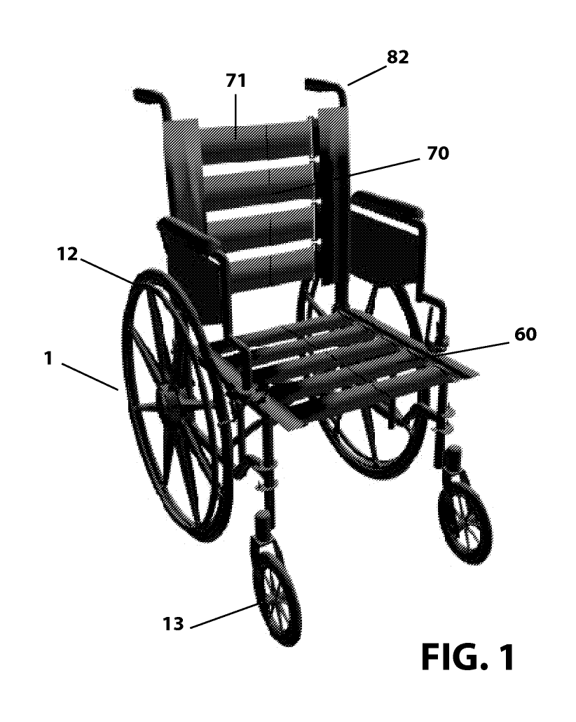

A wheelchair 1, shown in FIG. 1, has a seat 60 and a back rest 70. Further, the wheelchair has two pairs of wheels 12, 13. The wheels 12, 13 are pairwise of different sizes. The larger wheels 12 are placed largely straight beneath the back rest 70 but behind the point of gravity of the wheelchair 1 in order to prevent the wheelchair 1 from spontaneously tipping backwards. These wheels are typically large enough to allow for the user to push them and to propel the chair. Additionally these wheels can be equipped with quick release mechanisms to allow for easy removal and attachment. The front wheels 13 are typically smaller and are rotatable to allow for steering and are also easily attached and removed from the main frame.

In conjunction with or in the proximity of the back rest 70 there are disposed a pair of handles 80 that are intended to be held by someone other than the user for propelling the wheelchair 1. These are either fixed or adjustable and may come in a variety of sizes. Further, the wheelchair is provided with an optional pair of foot rests 26.

Wheels 12, 13, the seat 60, the back rest 70 and foot rests 26 are supported by a pair of side frame assemblies 10 and 11. Each of the side frame assemblies comprises sections for front and rear wheel attachment, foot rest attachment and arm rests. The rear portion of each of said side frame assemblies also has a section to either attach a height adjustable back rest structure or includes a rigid back rest structure as part of the entire assemblies. The side frame assemblies also have left side pivotal connecting members 20 and 21 and right side pivotal connecting members 22 and 23. The tubing for all support frame components is typically hollow metal tubing, but may be made of any material that has characteristics suitable for usage.

Although the wheelchair is described herein for adult sizing, it should be noted that the wheelchair is not restricted to adult usage. That is, the chair may be sized for pediatric usage, for bariatric usage, and is generally configurable to almost any size. Thus, in order for varying sized individuals to utilize the chair it is important to have a simple, widthwise adjustable seat.

A first embodiment is described with reference to FIG. 1. When the wheelchair is upright the left and right side frame assemblies 10 and 11 are perpendicular to the ground. Side frame assemblies each have arm rests, wheel connectors for front and back wheels and foot rest attachments that are similar to other wheelchairs currently in the market. Additionally, the wheelchair of the first embodiment has seat attachments and rear back rest attachments that are unique and distinct to the present invention and thus are specifically different from other wheelchairs currently in the market and that will be described in detail later.

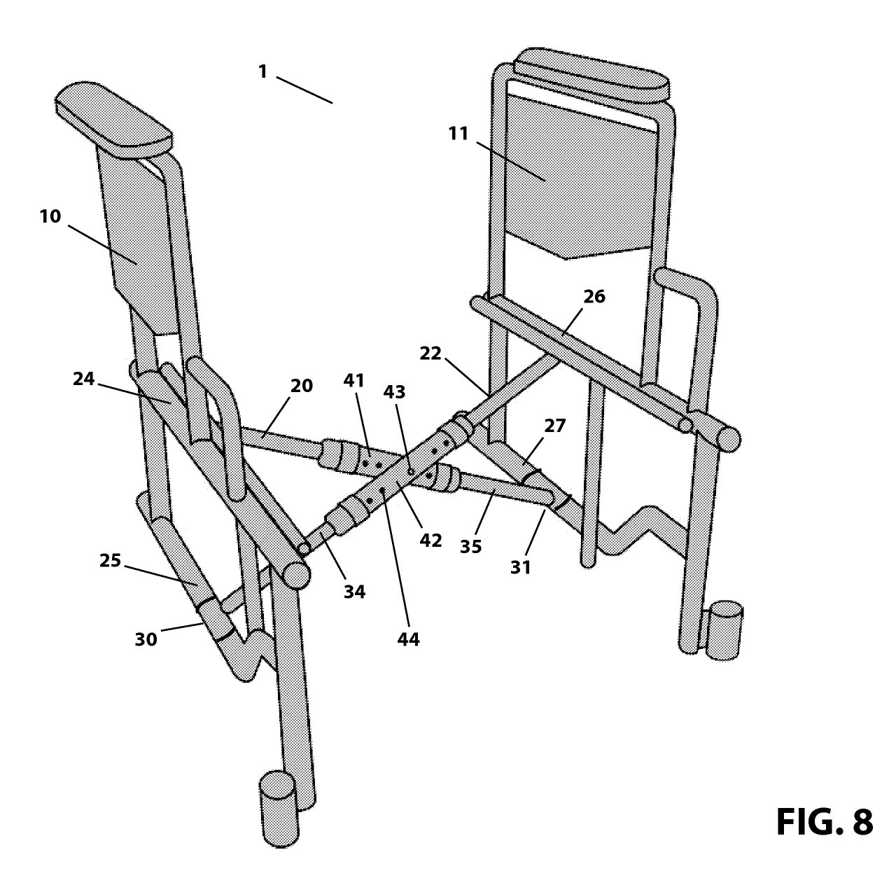

As shown in FIG. 8, each side frame assembly includes two, substantially horizontal, parallel bars; upper side bars 24, 26 and lower bars 25, 27. Permanently attached to each of said upper side bars 24 and 26 are legs 20 and 22. The lower parallel bar of each of the side frame assemblies have pivots 25, 27 that allow the chair to fold and compress. This pivot point is typically formed in a T-shaped rotational member 30 such that the X-member can pivot at X-member pivot point 43 thus allowing the chair to be sizeable. Each T-shaped rotational member 30, 31 has a top 32, 33 and a leg 34, 35 where the tops 32, 33 of the Ts are made from tubing slightly larger in diameter than lower pivot bars 25 and 27 such that the top members 32, 33 of the T shaped members are slid over each of parallel bars of lower bars 25, 27 so that each T member 30, 31 is rotatable about the bar each encompasses. Each of the T bottom legs 34, 35 and each of the top legs 20, 22 may have one hole or a series of holes 18 drilled therethrough. The T-members and the top legs are held in place by locking pins 17 where the locking pins 17 are placed through the holes 18 that are configured in the members once the seat width of the chair is set.

X-Member. As can be seen in FIGS. 8-11, the T-members are rotatably held in place as described above and are also held in place by a main X frame member. This combination of X frame member, T-members and legs allows configuration and solidification of the wheelchair frame in a variety of positions, including fully collapsed, fully expanded and numerous others in between. This X-member 40 is positioned between the left and right side frame assemblies 10 and 11. X-member 40 is comprised of two hollow tube members 41, 42 that have a slightly larger inside diameter than the outside diameter of the T bottom leg sections 34, 35 of T-members 30. Additionally, the hollow tube members 41, 42 also have a slightly larger inside diameter than the outside diameter of the upper legs 20, 22 such that upper legs 20, 22 may also be inserted into X-member 40. As noted, the reason for the difference in tubing diameter is to allow easy insertion of both T-legs 34, 35 and upper legs 20, 22 into the tubing of X-member 40. Once upper legs and T-legs are inserted into X-member 40 they are affixed in place. X-member 40 may have one hole or a series of holes 44 drilled therethrough as do upper legs 20, 22 and T-legs 34, 35. The holes 18 of each leg section are matingly drilled such that locking pin 17 may be inserted through both holes 18 and 44, thus locking the chair in a fixed position. In the present invention the holes are formed such that the chair can easily be configured to the presently common wheelchair sizes.

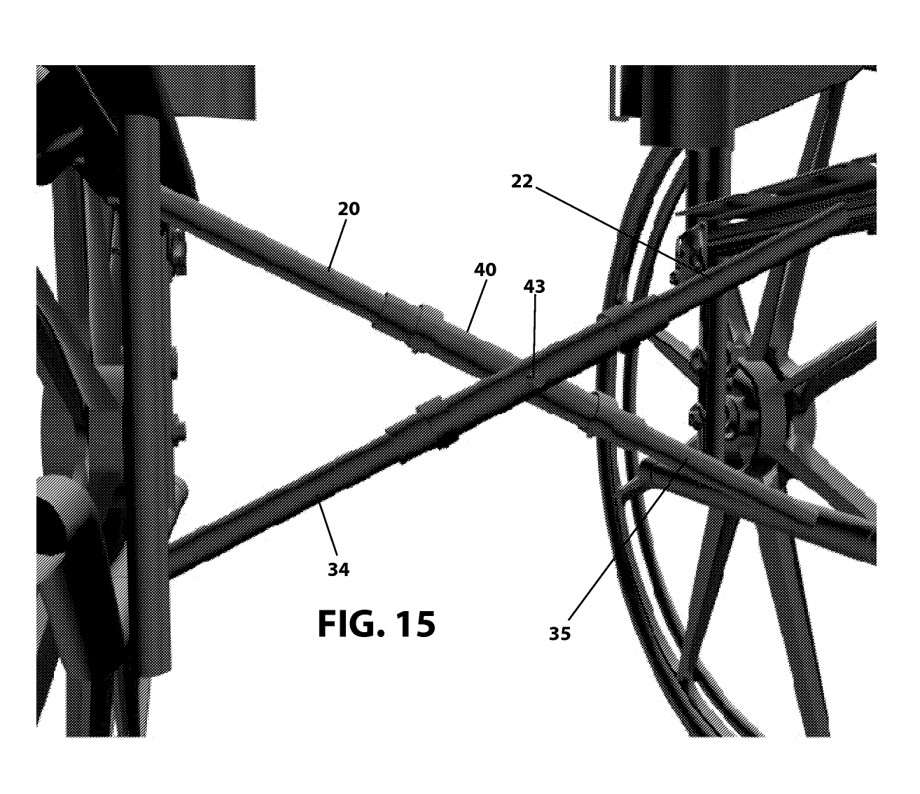

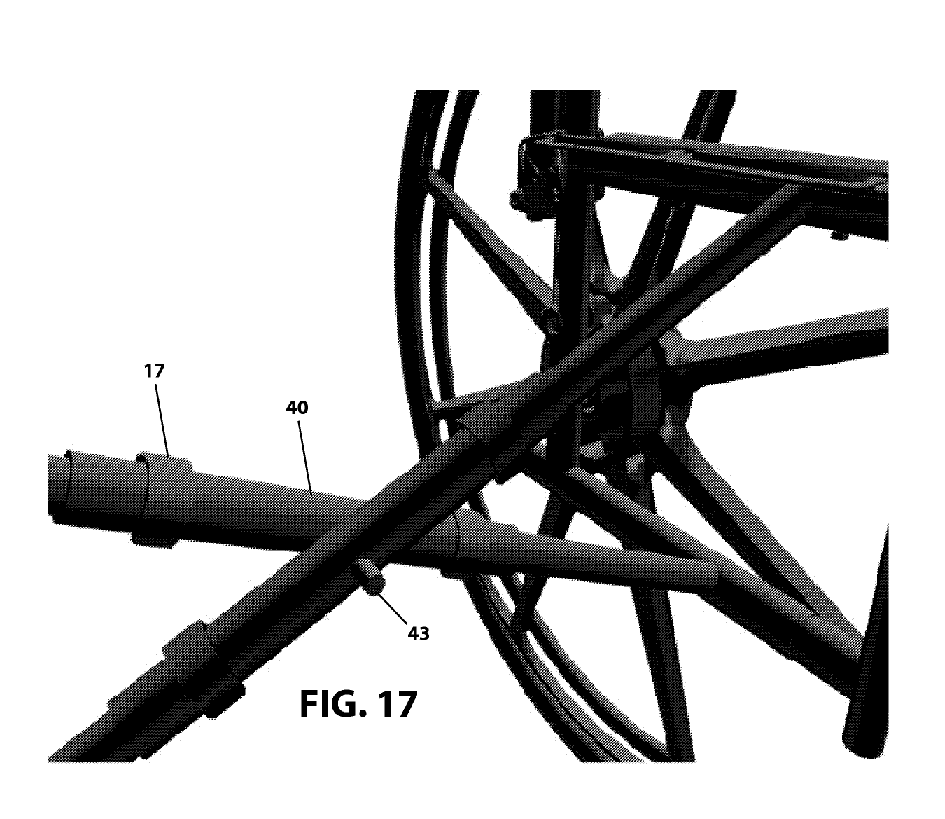

As shown in FIGS. 15 and 17, The hollow tube members 41, 42 of X-member 40 are pivotally connected at a midsection pivot point 43. Midsection pivot point 43 can be fastened together using a rivet, a bolt, or any other fastening means that allows the tube members to pivot in relation to each other. This pivot point is important as it allows easy chair configuration.

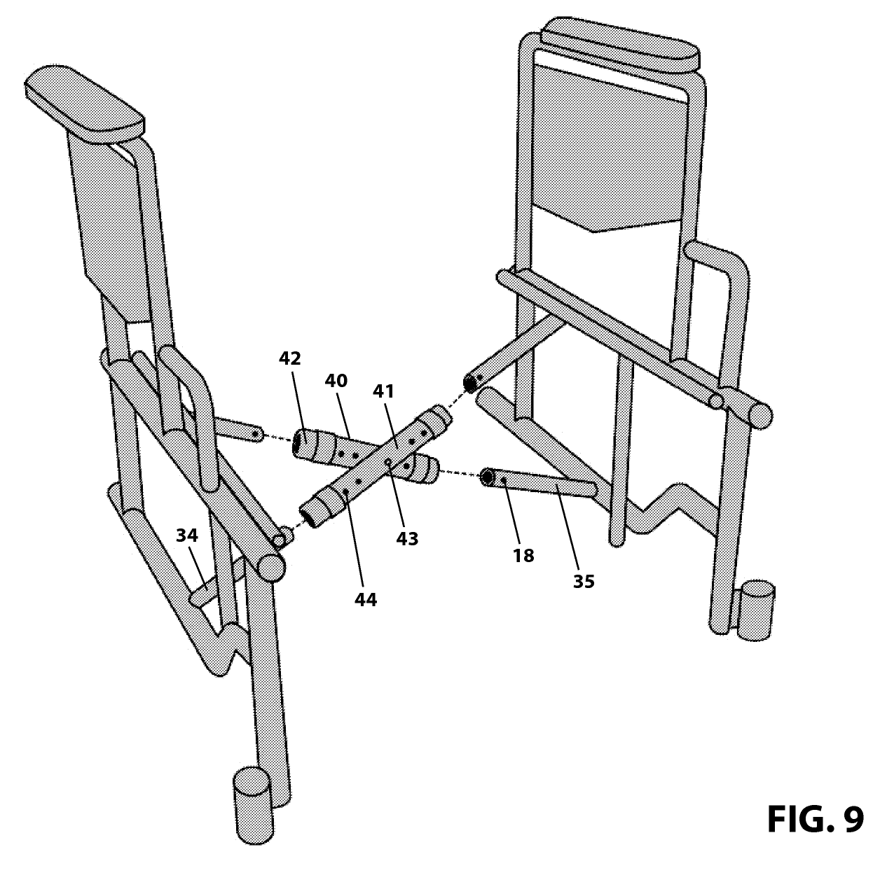

In order to assemble the chair appropriately the left and right side frame assemblies 10 and 11 are positioned in an upright manner. As clearly shown in FIG. 9, X-member 40 is positioned between the two frame assemblies and is aligned with T member legs 32. Each of T member 30 legs 32 are then matingly inserted into the matchingly appropriate legs of X-member 40. T member 30 holes 18 are matchingly aligned with X-member 40 holes 44 such that the members are slid either together or apart to the desired dimension. Typically the holes are configured to match the most common wheelchair sizes, currently seat widths of 16, 18 and 20 inches. These are the standard seat width dimensions for all standard manual folding wheelchairs presently in the market. Although these are the most common sizes it should be noted that the chair is not restricted to these limitations. Any length and/or diameter tubing and any hole configuration could be utilized to provide for a chair of any dimension, including those usable for excessively large chairs for bariatric patients, or alternatively for smaller chairs for children, as for use in pediatrics.

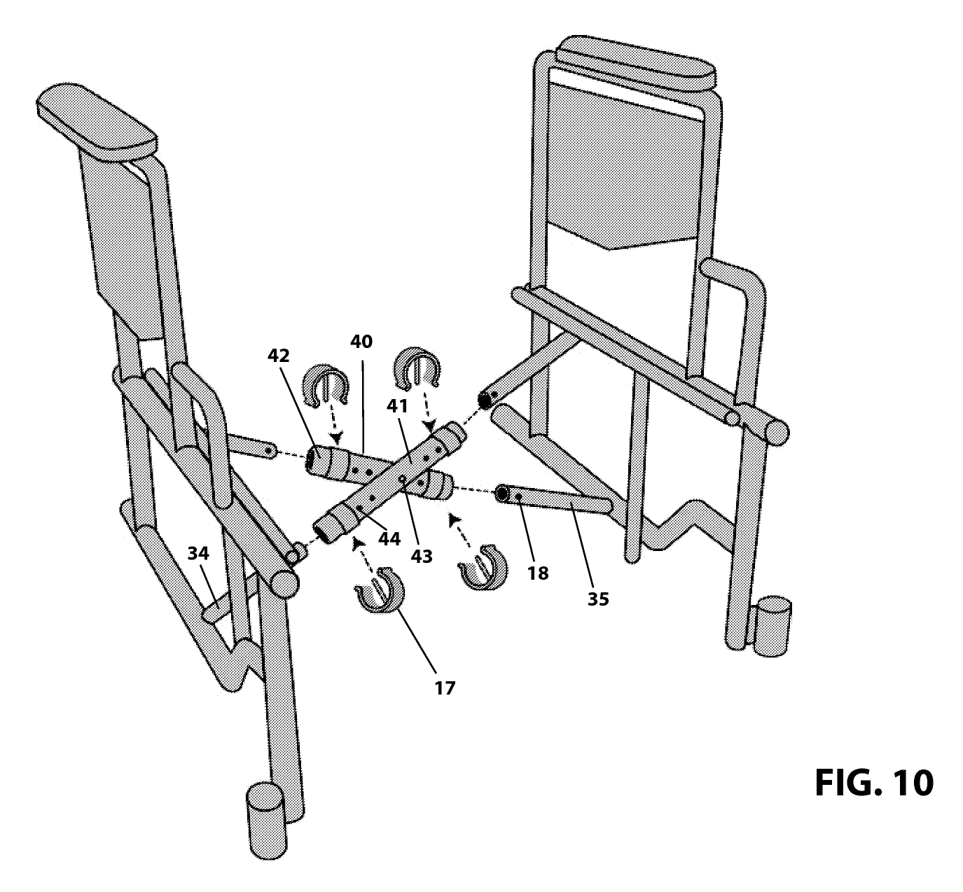

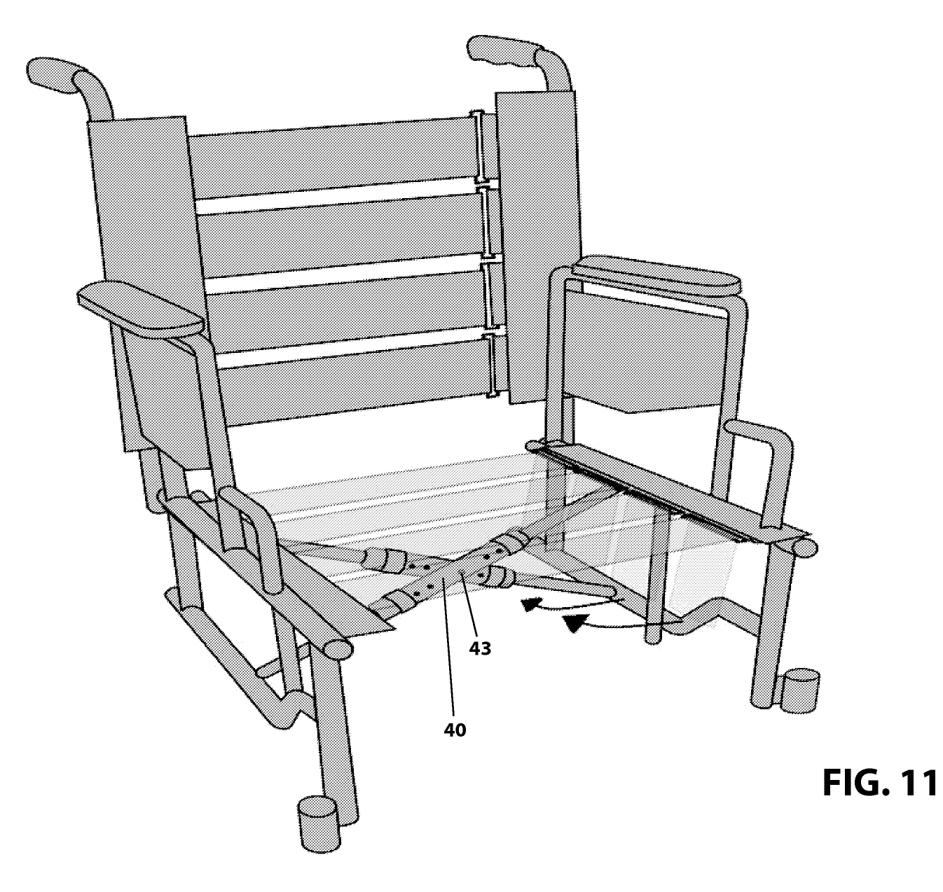

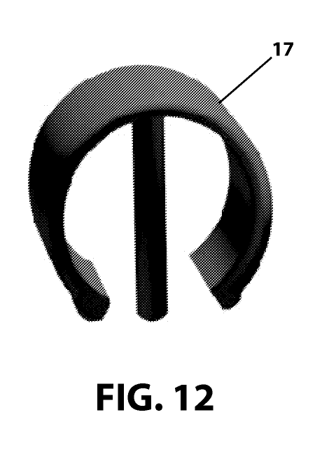

The width locking mechanism. In order to lock and secure the width at the selected dimension preferably snap ring connectors/locking pins 17 are provided, as shown in FIGS. 10 and 12. The mating tubes are slid together, the holes are aligned at a chosen dimension and the pins or snap ring connectors 17 are inserted through the appropriate holes, thereby locking the horizontal width in place, as shown in FIG. 11. The snap ring connectors 17 are preferred because they are easily obtainable, they are inexpensive and they are easy to use. Even though the snap ring connectors 17 are preferred it is noted that the pins can be any variety, including the common “push pin” mechanism locking pin; a separate locking pin; snap ring with locking pin or any variety of locking mechanism that will secure the tubes in place. After the chair is set to the desired width the pins are inserted, locking the width in place. Thereafter, if the wheelchair has removable and adjustable back support portions, the user inserts the rear backrest support portions 70 into position and locks those in place. Otherwise, the back support portions will be attached as rigid parts of the side frame members 10, 11.

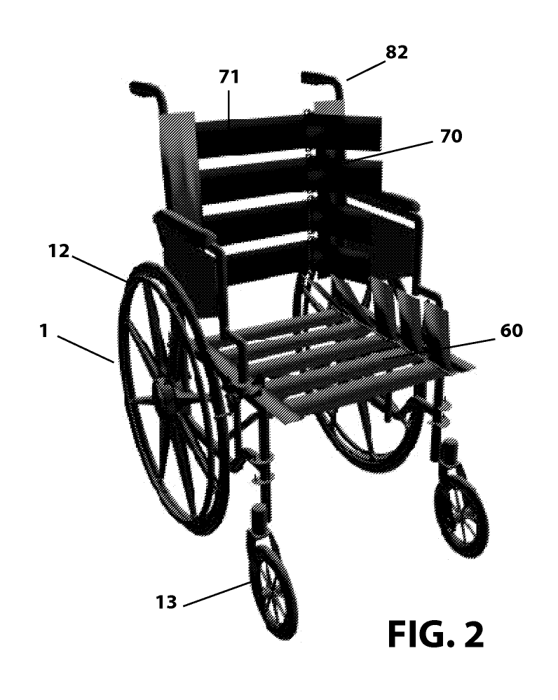

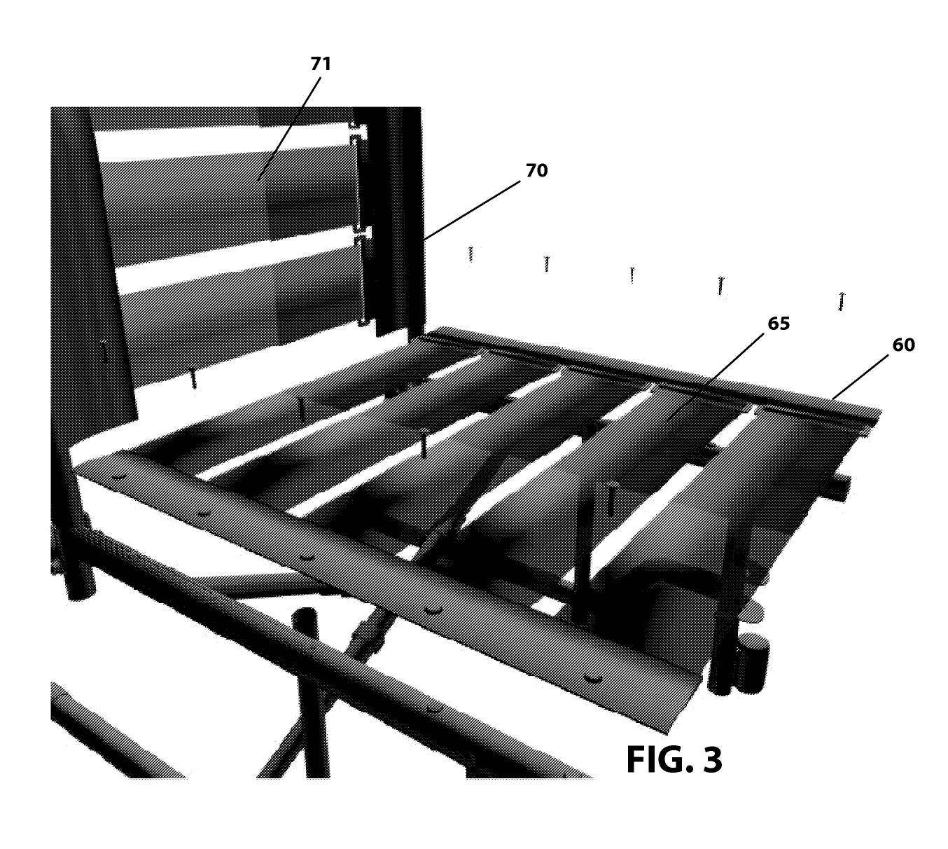

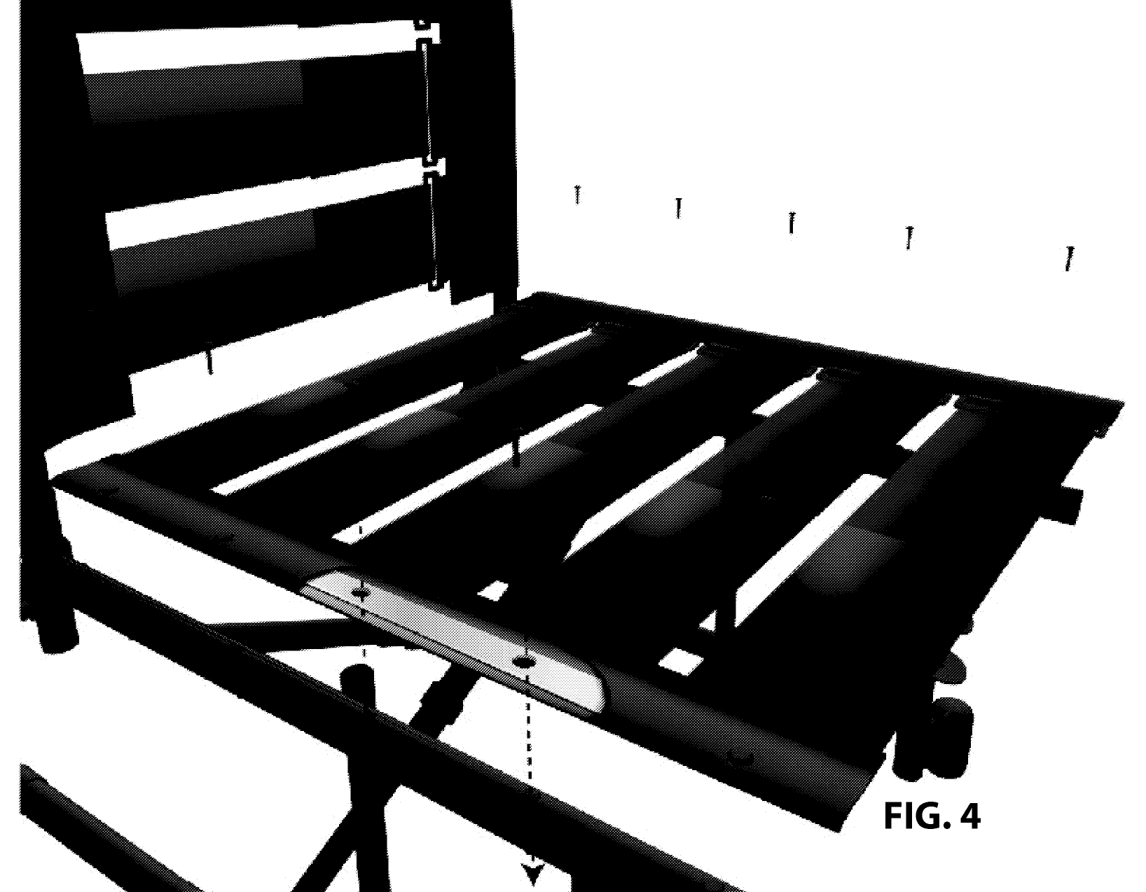

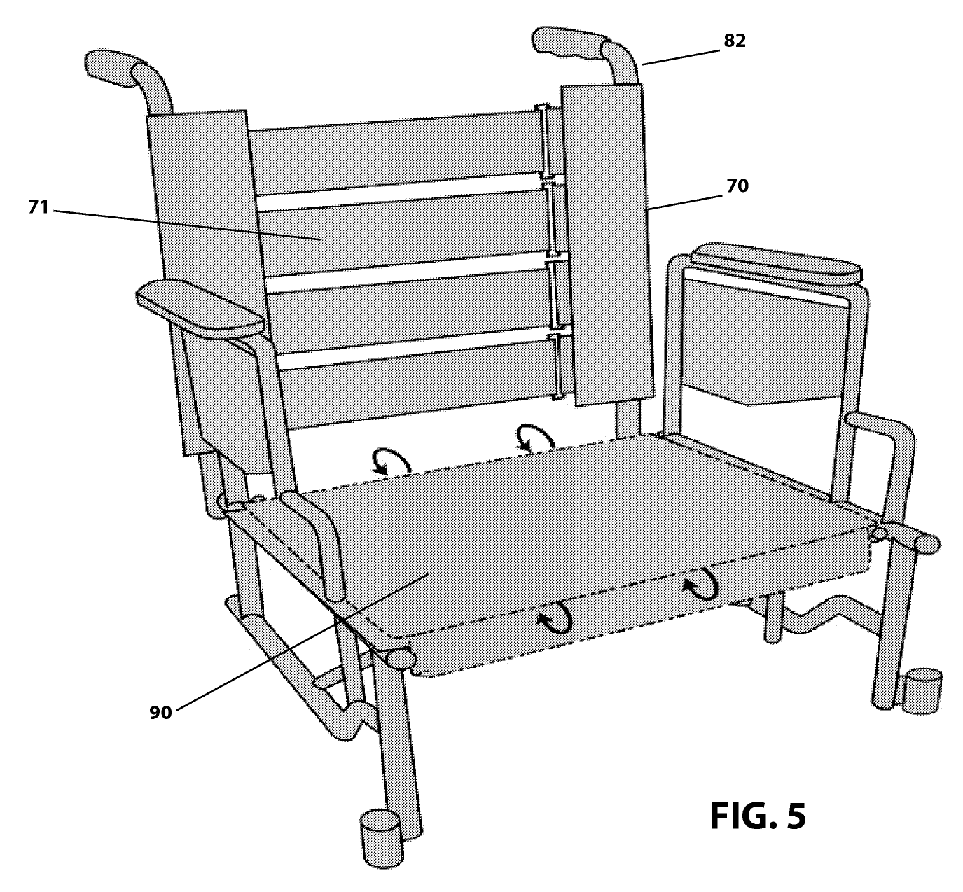

The seating and back structures. The seating and back structures are shown in FIGS. 1 through 6. In the embodiments shown there are four straps 71 for the backing and five straps 65 for the seating. However, the number of straps can be more or less depending on the width of the material used and depending on the size of the chair. The seat straps 65 are secured to upper side bars 24, 26 that are positioned either adjacent to or slightly above upper bars 24, 26. The seat straps 65 may be attached with hook and loop/Velcro™, but in the preferred embodiment the straps 65 are permanently attached to upper side bars 24, 26. In the preferred embodiment the straps 65 are securely fastened on a first secured side 51 of the chair by sewing, rivets, or some other securing means. The other side of the chair has a second secured side that is also secured by sewing, rivets or some other securing means and additionally has a series of buckles 53 permanently attached to the second secured side. The secured straps extend from the first secured side, between the opposing side assemblies 10, 11, through the buckles 53 on the opposite side and then are fixed in place either on the seating portion or on the bottom side of the seating portion using Velcro™ such that the Velcro™ straps are securely fastened each time the width of the frame is adjusted. It is also preferable that the strap is run through the buckle from the bottom up so that the loose portion then lays over the seating portion such that the user is using his weight to help secure and hold the Velcro™ connection in place. This configuration allows for a wide array of adjustability and does not limit the chair dimensions. Additional seat and back cushions 90 of varying widths (depending on the width of the frame) are then placed over the Velcro™ straps to provide additional comfort and support for the user of the wheelchair.

It is extremely important that the straps are securely fastened to the side assemblies 10, 11. Because the straps are secured to the sides the user is able to vary the tension of the straps as the width of the frame is changed. Additionally, the straps must be securely fastened to the side assemblies 10, 11 in order to provide exceptional safety.

This same secured strap design is utilized for the backing portion 70 of the chair as well and can be used for either a removable and height adjustable backing portion or a rigid backing portion. The secured strap design of the preferred embodiment is innovative for two main reasons. First, the wheelchair user has the ability to adjust the tension of the seat or back for the patient. For example, if a patient needs to sit in the chair where it is required that the user's hips are positioned lower than the user's knees for clinical reasons (i.e. amputee patients), the user can vary the tension of the straps 65 from the rear to the front of the frame by making the straps in the rear looser and the straps in the front tighter. Obviously this could be done in the reverse manner so that the back seating section is tighter and the front section is looser allowing the patient or user to more easily get out of the chair. With respect to the chair backing, the Velcro™ straps can also be adjusted to provide differing comfort configurations for different users. For example, if a user has difficulty getting out of the chair the backrest 70 can be configured such that the lower straps are loose and the upper straps are tight, thus providing a forward pushing configuration. However, if the user suffers from lower back pain the straps can be configured to provide additional lumbar support. In this configuration the lower straps would be tighter and the upper straps would be looser. Obviously, there are numerous configurations available that are only limited by the number of straps employed and these configurations are in no way limited by the description hereof.

The Velcro™ strap design requires the use of additional seat and back paddings 90 of different widths that can be attached and removed from the Velcro™ straps. This is advantageous because wheelchair users, dealers, nursing homes and hospitals can remove the seat and back padding to wash and disinfect the padding so that it can be reused for multiple patients or simply for cleaning and sanitizing purposes. This is exceptionally beneficial because currently the seats and backs are integrally incorporated into the chair making them difficult or even impossible to remove. Thus, if the seat and/or back padding becomes too dirty to clean or if it becomes damaged the user will typically have to either buy a new chair or new seat upholstery. With the preferred embodiment design the user can simply remove the padding and clean it for reuse without having to buy a whole new chair or seat upholstery. Obviously this is extremely beneficial to the user as it provides an easy, convenient means to clean the chair without having to spend additional monies on a new chair simply because the old chair seat became soiled.

After the tubing is set to the desired dimension and the seating configured, separate removable back sections can be installed and adjusted. For maximum adaptation to different users the back rest 70 can be separately attachable in relation to the seat and will be described next. The back rest 70 uses either a simple, fixed back cane 81, 82 configuration or an adjustable back cane configuration. The back rest 70 may utilize the same basic adjustment mechanism used in the seat width adjustment. The side frame assemblies 10 and 11 can have back rest insertion tubes 73, 74 for inserting back rest canes 81, 82 therein. The back rest canes can be attached using a system as described above with different sized tubing so that one tube is sleeved over the other tube to provide easy adjustability. Then, the tubes are secured in place using either mounting screws and lock nuts or alternatively they can be mounted using a system as described above where canes 81, 82 are slid into insertion tubes 73, 74 and are then either fixed using locking pins or the above described mounting screws and lock nuts.

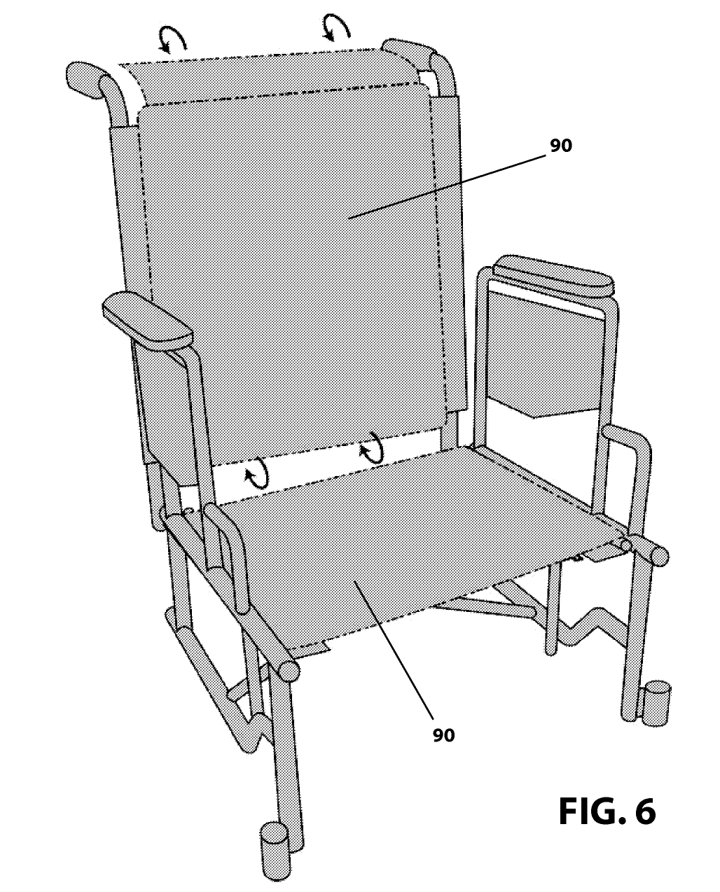

After the tubing is set to the desired dimension the seat backing area is adjusted. In the preferred embodiment the backing is formed utilizing adjustable straps 71. In the embodiment shown there are four straps 71. However, the number of straps could be more or less depending on the width of the material used or the user's preferences. The straps may be secured to back canes 81, 82 with Velcro™ or some other adjustable material. However, in the preferred embodiment one end of the mating straps is permanently attached to opposing back canes 81, 82. Next, the other end of the straps meet in the middle section between back canes 81, 82 and are then connected in the middle, again using Velcro™ or the like. Preferably, the straps are securely attached to one side by sewing, rivets or some other securing means. The opposite side is securely attached by sewing, rivets, or some other securing means and also has buckles 72 that are securely attached. The loose ends of the straps 71 are passed through the buckles 72 and are then returned to the center for easy tightening and adjustment. The center of the strap utilizes Velcro™ or some other mechanism to securely attach the strap to itself. This allows for a wide array of adjustability and does not limit the chair dimensions. Additionally, as shown in FIG. 6, padding may be added over the straps to provide more comfort and as described above for the seating, this allows for easy removal and cleaning of the pads.

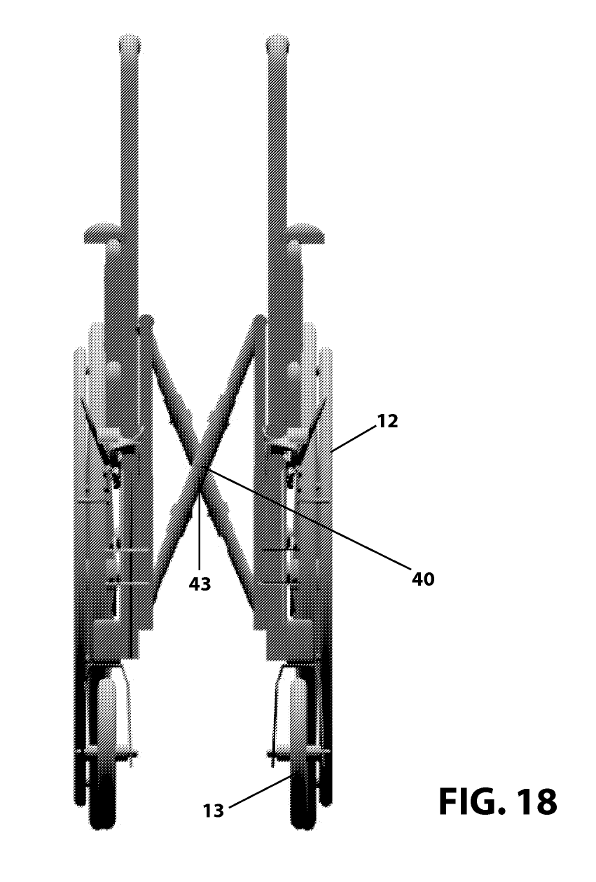

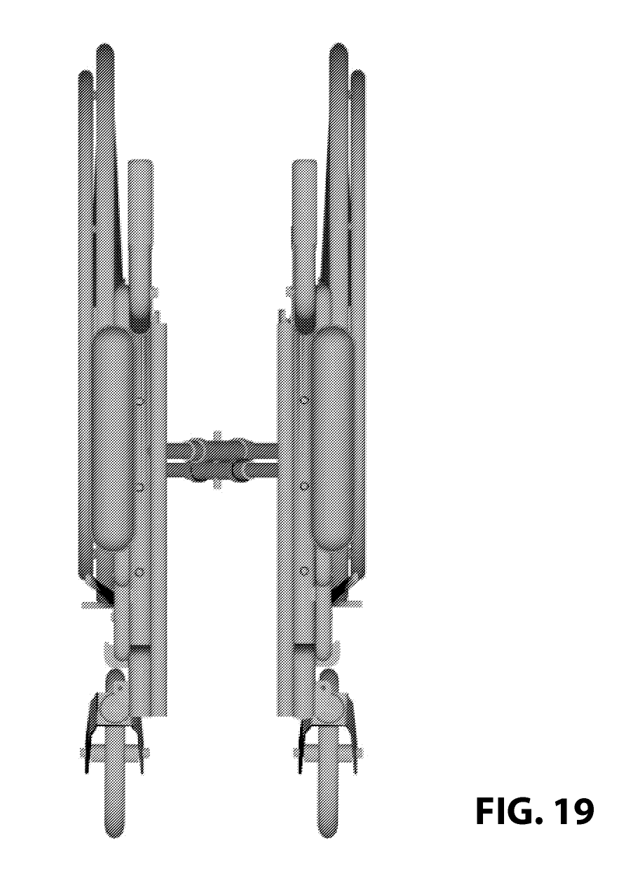

Finally, the chair design, and specifically the X-member 40 configuration, allows for easy transportability. When the user wants to transport the chair the chair is simply folded in scissors fashion, similar to many chairs now in the market, as shown in FIGS. 18 and 19. Additionally, in order to facilitate transportability, the large rear wheels 12 can utilize quick release mechanisms that facilitate easy removal. As can be seen in FIG. 1, the large wheels can be attached to the each of the side assemblies with quick disconnect components. These wheels are typically standard type quick release components that utilize a “push pin” axel that is inserted through lower holes in the rear portion of the side bases. Also, the push handles, front wheels, and foot rests are easily removed for convenient transportation. The removable front wheel may also use a quick release mechanism. However, it is totally acceptable to simply attach the front wheels with a bolt and nut as on a standard wheelchair.

In many cases the user may need foot rests 26, 36. These are disposed on the same part of the side assemblies 10, 11 as the small wheels 13. Moreover, they are adjustable, for example may be angled, for adaptation to the user of the wheelchair 1, partly in respect of the user's body size and partly in respect of the user's method of using the wheelchair 1. Further, the foot rests 26, 36 are raisable and lowerable if the need for them is only temporary. As noted above, the foot rests may also be wholly dismounted if the user has no need for them at all. Naturally, it is also possible to dismount only one of the foot rests 26, 36. Regardless of how the foot rests are adapted, their adjustment will remain unchanged on raising and lowering of the seat and regardless of any other adjustments.

It should be noted that the armrests, rear wheels and front wheels shown are common in the industry and are in no way unique to this invention. While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. For example, the wheelchair can be of any dimension or size to accommodate children or adults of any size, the tubing could be cylindrical, square, or any other shape, the connector pins can be any variety of connector that will provide a secure connection, or the wheels can be of any variety. Therefore, the invention, in its broader aspects, is not limited to the specific details, the representative apparatus, and illustrative examples shown and described. Accordingly, departures can be made from such details without departing from the spirit or scope of the applicant's general inventive concept.

1. An adjustable wheelchair comprising:
a pair of spaced side assemblies that support a pair of wheels, a seat and a backrest;
at least a pair of T-members that are rotatably connected to said side assemblies;
at least a pair of legs that are securely fastened to said side assemblies;
an X-member formed by at least two hollow tubes that are pivotally connected where said X-member is placed between said side assemblies and where said T-members and said legs are adjustably lockable to said X-member.

2. The adjustable wheelchair of claim 1 where the inside diameter of said X-member is larger than the outside diameter of said T-members and said legs so that said T-members and said legs are slideably and lockably insertable into said X-member.

3. The adjustable wheelchair of claim 1 where the outside diameter of said X-member is smaller than the inside diameter of said T-members and said legs so that said X-member tubes are slideably insertable and lockable into said T-members and said legs .

4. The adjustable wheelchair of claim 1 where
said hollow tubes of said X-member have a series of holes;
said T-members have a series of holes;
said legs have a series of holes; and
where said holes of said T-members and of said legs are matingly alignable with said holes in said X-member such that a width of said wheelchair is adjustable and where after adjusting to desired width a locking mechanism is inserted through said holes so that said width is then locked in place using said holes.

5. The adjustable wheelchair of claim 4 where the locking mechanism is a snap ring connector.

6. The adjustable wheelchair of claim 1 where the seat and backrest are formed using straps.

7. The adjustable wheelchair of claim 6 where the straps used to form the back are securely affixed to a first back cane and a buckle is securely affixed to a second back cane,
where the straps are stretched between the two back canes,
are then run through said buckle,
are brought back and over themselves and
are then securely affixed to themselves.

8. The adjustable wheelchair of claim 7 where the straps are securely affixed to themselves using Velcro™.

9. The adjustable wheelchair of claim 6 where the straps are used to form the seat are securely affixed to a first of said side assemblies and a buckle is securely affixed to a second of side assemblies,
where the straps are stretched between the two side assemblies,
are then run through said buckle,
are brought back and over themselves and
are then securely affixed to themselves.

10. The adjustable wheelchair of claim 9 where the straps are securely affixed to themselves using Velcro™.

11. The adjustable wheelchair of claim 8 further including a separate, removable pad to cover said straps.

12. The adjustable wheelchair of claim 10 further including a separate, removable pad to cover said straps.
